(19) United States
(12) Patent Application Publication
(10) Pub. No.: US 2013/0146531 A1
(43) Pub. Date: Jun. 13, 2013

(54) FEED SPACERS FOR SPIRAL WOUND MEMBRANE ELEMENT

(71) Applicants: Yatin TAYALIA, Singapore (SG); Prasanna Rao DONTULA, Bangalore (IN); Upen Jayant BHARWADA, Scottsdale, AZ (US)

(72) Inventors: Yatin TAYALIA, Singapore (SG); Prasanna Rao DONTULA, Bangalore (IN); Upen Jayant BHARWADA, Scottsdale, AZ (US)

(73) Assignee: GENERAL ELECTRIC COMPANY, Schenectady, NY (US)

(21) Appl. No.: 13/315,423

(22) Filed: Dec. 9, 2011

(51) Int. Cl. B01D 63/00; B29C 43/02

(52) U.S. Cl. 210/541; 264/331.11

(57) ABSTRACT

A feed channel spacer for a spiral wound membrane element has inlet and outlet edges that are thinner than the rest of the spacer material. The edges may be made thinner, for example, by passing the edges of a sheet of feed spacer material through a pair of hot rollers or by compressing the edges of the sheet in a heated press. The thinned edges of the feed spacer material are located in the element between glue lines applied to the permeate spacers of the element. The thin edges allow a greater membrane surface area to be provided in a given element diameter. A feed channel spacer may also have an area with obstructions to create micro-mixing effects. These obstructions may be provided on a feed spacer sheet of constant thickness, or one with thin edges.

### FIELD

The present disclosure relates to spiral wound membrane elements and to feed channel spacers for spiral wound membrane elements.

### BACKGROUND

The following discussion is not an admission that anything described below is common general knowledge or citable as prior art.

A spiral wound membrane element is manufactured by rolling one or more membrane envelopes around a perforated central tube. Each envelope comprises two membrane sheets glued along their three outer edges to a permeate spacer. Adjacent membrane sheets are separated on a feed side by a feed channel spacer, which may also be called a brine channel spacer. In use, the element is enclosed in a tubular pressure vessel. Feed water enters at an upstream end of the tubular vessel and flows across the feed channel spacer. A portion of the feed flows through the membrane sheets, through the permeate spacer, and out of the pressure vessel by way of the perforated central tube. The remainder of the feed water exits the feed channel as concentrate and is withdrawn from a downstream end of the pressure vessel. US Patent Application Publication Number 2007/0068864 describes one example of a spiral wound membrane element.

A feed channel spacer is normally made of a sheet of plastic (for example polypropylene) mesh or netting. The primary purposes of the feed channel spacer is to create a space for the feed water to flow between adjacent membrane envelopes, and to create turbulence on the surfaces of the membranes. The turbulence reduces concentration polarization and so increases the net driving pressure available to generate permeate. However, the feed channel spacers also create a head loss to feed flow which reduces the net driving pressure. These effects must be balanced, along with the volume occupied by the feed channel spacer and its ability to resist being fouled by contaminants in the feed water.

Common thicknesses of feed channel spacers include 26 mils (0.66 m), 28 mils (0.71 mm), 31 mils (0.79 mm) and 34 mils (0.86 mm). In general, the thinner spacers consume less volume and so allow more membrane surface area to be provided in an element of a given outer diameter. However, the thinner spacers result in greater head loss and are also more prone to fouling or plugging, which further increases head loss. Thicker feed spacers are better able to resist fouling and so are used with high fouling feed water.

Numerous attempts have been made to provide feed channel spacers with special geometries that resist fouling or reduce concentration polarization at the membrane surface. For example, US20040182774 to Hirokawa et al. discloses a feed side spacer having warps almost parallel to the direction of flow, and wefts, thinner than the warps, at a prescribed pitch designed to reduce the pressure drop on the feed side as well as reduce clogging of the feed channel. For further example, Ahmad and Lau, in “Impact of different spacer filaments geometries on 2D unsteady hydrodynamics and concentration polarization in spiral wound membrane channel”, Journal of Membrane Science 286 (2006) 77-92, use computational fluid dynamics to demonstrate that a mesh spacer with strands of circular cross-section is more efficient at reducing the effect of concentration polarization than a mesh spacer with strands of rectangular cross-section. Lau et al., in “Feed spacer mesh angle: 3D modeling, simulation, and optimization based on unsteady hydrodynamic in spiral wound membrane channel”, Journal of Membrane Science 343 (2009) 16-33, use computational fluid dynamics to demonstrate an optimal included angle between the strands in a mesh-type spacer to reduce the effect of concentration polarization. However, a square or diamond shaped net, made with one set of parallel filaments below a second set of parallel filaments oriented obliquely to the first set, remains standard in the field.

### BRIEF DESCRIPTION OF THE INVENTION

A feed channel spacer described herein has regions or borders, at the inlet and outlet edges of the feed channel spacer, that are thinner than a central part of the feed channel spacer.

In a spiral wound membrane element, a feed channel spacer as described above is located between adjacent membrane leaves of the element. In each membrane leaf, a permeate carrier is located between upper and lower membrane sheets and an adhesive is applied at least in two lines along the side edges of the leaf, which are perpendicular to a central tube. The thinned edges of the feed channel spacers are located between the lines of adhesive of adjacent membrane leaves.

After the membrane leaves and feed channel spacers are wound around the central tube, the side edges of the membrane leaves with their attached lines of adhesive extend in a spiral around the central tube. Because of the thickness of the adhesive, the ends of a typical membrane element with a feed channel spacer of uniform thickness have a larger diameter than the central part of the element. The outer diameter at the ends of the element limits the number or length of membrane leaves that may be placed in a pressure vessel of a given inside diameter. Providing relatively thin edges on the feed channel spacers at least reduces any increase in diameter at the ends of an element that would otherwise be caused by the adhesive. Accordingly, more or longer membrane leaves may be placed in a pressure vessel of a given inside diameter if feed channel spacers with thin edges are used, thus increasing the active membrane area of the element.

A process for making a feed channel spacer with thin edges comprises heating and compressing the edges of a sheet of spacer material. For example, the edges may be made thinner by passing the edges of a sheet of feed spacer material through a pair of hot rollers or by compressing the edges of the sheet in a heated press.

Another feed channel spacer described herein has an area with obstructions to fluid flow. The obstructions may be laid out in an array with subsequent rows staggered from each other. The obstructions may be provided with a feed spacer sheet of constant thickness, or with one having relatively thin edges.

### BRIEF DESCRIPTION OF THE DRAWINGS

FIG. 1 is a cut-away perspective view of a spiral wound membrane element.

FIG. 2 is a schematic plan view feed channel spacer having thin edges.

FIG. 3 is a schematic section along the line III-III of the feed channel spacer of FIG. 2.

FIG. 4 is a schematic plant view of another feed channel spacer having thin edges and a region with obstructions.

FIG. 5A is a schematic section along the line V-V of the feed channel spacer of FIG. 4.

FIG. 5B is a schematic section along the line V-V of FIG. 4 showing an alternative construction of the feed channel spacer of FIG. 4.

### DETAILED DESCRIPTION

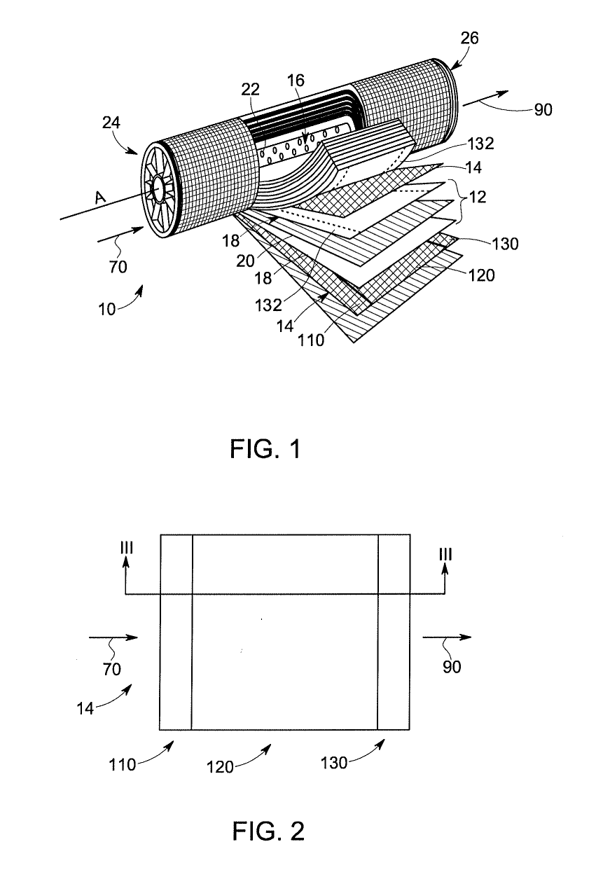

Referring to FIG. 1, a spiral wound membrane element 10 is formed by wrapping one or more membrane leaves 12 and feed channel spacers 14 around a perforated central tube 16. The membrane leaves 12 may also be called envelopes. The feed channel spacers 14 may also be called brine channel spacers. The central tube 16 may also be called a core, a permeate tube or a product water collection tube. The leaves 12 comprise two generally rectangular membrane sheets 18 surrounding a permeate carrier 20. The edge of the membrane leaf 12 abutting the central tube 16 is open, but the other three edges of a leaf 12 are sealed, for example by an adhesive. Less frequently, the two membrane sheets 18 of a membrane leaf 12 may be attached through a fold line at the tip of the leaf, in which case only the two side edges of a membrane leaf 12 are sealed with adhesive.

The membrane sheets 18 may have a separation layer cast onto a supporting or backing layer. The separation layer may be, for example, cellulose acetate, a polyamide, a thin film composite or other materials that may be formed into a separation membrane. The separation layer may have pores, for example, in the reverse osmosis, nanofiltration or ultrafiltration range. Filtered product water, also called permeate, passes through the membrane sheet while the passage of dissolved salts or suspended solids or other contaminants are rejected by the membrane sheet 18 depending on its pore size. The permeate carrier 20 is in fluid contact with rows of small holes 22 in the central tube 16 through the open abutting edge of the membrane leaf 12.

Each leaf 12 is separated by a feed channel spacer 14 that is also wound around the central tube 16. The feed channel spacer 14 is in fluid contact with both ends of the element 10 and it acts as a conduit for feed solution across the surface of the membrane sheets 18. The element 10 is placed inside of a pressure vessel (not shown) when in use, and feed water is introduced into one end of the pressure vessel. Feed water 70 flows through the element 10 from the entrance end 24 to the concentrate end 26 parallel to the axis A of the central tube 16. After passing through the element 10, the feed water 70, less any water that has been permeated, leaves the elements as concentrate 90, alternatively called retentate or brine.

A membrane leaf 12 tends to have side edges 132, which are the edges perpendicular to the central tube 16, that are 2 to 5 mil, or 10 to 22%, thicker than the remainder of the membrane leaf 12. The increase in thickness is caused by the adhesive, alternatively called glue lines, used to seal the edges of a membrane leaf 12. Since the outer diameter of an element 10 is typically maintained within a narrow range relative to the inside diameter of the pressure vessel that will surround the element 10, the limiting diameter of the element 10 is typically formed in the area of the side edges 132 of the membrane leaves 12. The width of the glue lines may vary between, for example, about 25 mm with automatic glue application and about 30 mm to 45 mm with manual glue application.

FIGS. 2 and 3 show a feed channel spacer 14 having edges 110, 130 that are thinner than a central part 120 of the feed channel spacer 14. Referring to FIG. 1, a feed edge portion 110 of the feed channel spacer 14 is located between the glue lines 132 on the side edges of the membrane leaves 12 near the entrance end 24 of the element 10. A concentrate edge portion 130 of the feed channel spacer 14 is located between glue lines 132 on the side edges of the membrane leaves 12 near the concentrate end 26 of the element 10.

The edges 110, 130 may be made of a different material than the central part 120 of the feed channel spacer 14, or the edges 110, 130 may be treated to reduce their thickness. For example, the edges my be made by taking a sheet of thermoplastic mesh or netting, as is typically used to create feed channel spacers, and compressing the edges of the sheet between a pair of rollers or a press. The rollers or press are preferably heated to above the heat deflection temperature of the sheet while pressing the edges 110, 130 of the sheet such that the edges 110, 130 are permanently deformed to a reduced thickness. Alternatively, a feed channel spacer 14 may be made in three pieces. In this case, the central portion 120 is made of feed channel spacer material having one thickness and the edges 110, 130 are made of feed channel spacer material having a lesser thickness.

Referring to FIG. 3, the central portion 120 has a first thickness 170. The first thickness 170 may be any thickness appropriate for a spiral wound membrane, for example between 0.6 mm and 1.2 mm. The feed edge portion 110, and the concentrate edge portion 130, have a second thickness 160. The second thickness 160 is less than the first thickness 170. For example, the second thickness 160 may be between 2 and 12 mil less than the first thickness 170. Using a feed channel spacer 14 having relatively thinner edges 110, 130 allows a larger membrane area to be packed into the spiral wound element 10 of a given outside diameter resulting in a higher permeate flow per element 10.

While the thinned edges might at first appear to increase head loss, the flow through the edges 110, 130 is generally laminar, and the edges are typically less than 5 cm wide. Accordingly, any increase in head loss is small. However, the membrane surface area may be increased, for example by 5% or more or 10% or more. The increase in membrane area more than compensates for any decrease in net driving pressure allowing permeate flux to be increased for a given outside diameter of an element 10. Alternatively, if an existing element 10 has difficulty filtering feed liquids with a propensity to foul the feed channels, it may be advantageous to use a feed channel spacer 14 with the same thickness as the existing feed channel spacer at the edges 110, 130, but with a greater thickness in the central portion 120. The central portion 120 may be made thicker, for example, between 2 and 12 mils thicker, without materially decreasing the membrane surface area.

Referring to FIG. 4, a second feed channel spacer 140 shown is similar to the feed channel spacer 14 in having thinner edges 110, 130. However, in the second feed channel spacer 140, the thinner edges 110, 130 are optional and the second feed channel spacer may have a uniform thickness.

The second feed channel spacer 140 has a region 200 that includes a plurality of obstructions 190. The region 200 shown in FIG. 4 occurs only at the tip of the second feed channel spacer 140, which is the region of the second feed channel spacer 140 that will be located near the outside of the element 10, furthest from the central tube 16. Alternatively, the region 200 may occur in other parts of the second feed channel spacer 140 including throughout the entire second feed channel spacer 140.

In plan view, as shown in FIG. 4, the obstructions are provided in a staggered pattern or array across a portion of the width (for example between edges 110, 130) of the second feed channel spacer 140. Subsequent rows are staggered in a nominal direction 80 of feed flow through the second feed channel spacer 140. FIG. 4, and the other Figures, are not to scale, and the obstructions 190 are much more numerous and closer together than illustrated. The centre to centre distance between adjacent obstructions 190 may be 20 mm or less. The gap between obstructions 190, measured perpendicular to the nominal direction feed flow direction 80, may be between 0.5 and 5 mm. The diameter of the obstructions 190, or their width perpendicular to the nominal direction 80 of feed flow if they are not round, may be between 1 and 5 mm.

The obstructions 190 cause the feed water to flow in a curving local feed flow path 82. The curvature of the local feed flow path 82 may vary, but at least some portions, for example 50% or more, of the local feed flow path 82 preferably have a radius of curvature of between 1 mm and 10 mm. The curvature causes the feed water flowing through the local feed flow path 82 to experience micro-mixing effects such as Dean vortices. This micro-mixing inhibits concentration polarization on the surfaces of the membranes 18.

The obstructions 190 are oriented generally vertically when the second feed channel spacer 140 is oriented horizontally. The obstructions 190 may be cylindrical, or they may have a conical or dome shape to reduce their area of contact with the membranes 18. Referring to FIG. 5A, in a second feed channel spacer 140A the obstructions 190 are supported on a central sheet 192. Each obstruction 190 extends from the central sheet 192 to the top or bottom of the second feed channel spacer. The obstructions 190 may be made, for example, of deposits of an adhesive or plastic placed on the central sheet 192. Alternatively, the obstructions 190 may be made by forming dimples in a thermoplastic central sheet 192. In that case, the pattern of obstructions 190 on one side of the central sheet 192 is offset from the pattern of obstructions 190 on other side of the central sheet 192. Referring to FIG. 5B, in another second feed channel spacer 140A, the obstructions 190 are supported by a mesh or net feed spacer material 194 of the first width 170. These obstructions 190 pass through the width of the second feed channel spacer 140A. In this case, the obstructions 190 are formed by deposits of an adhesive or plastic attached to the feed spacer material 194.

In FIG. 4, the region 200 occurs only at the tip of the second feed channel spacer 140. The tip of a feed channel spacer tends to carry less feed flow than the base of a feed channel spacer. In some cases, the tips of the membrane leaves 12 do not fully participate in filtration because the feed flow velocity is insufficient to inhibit concentration polarization. The obstructions 190 reduce the area available for flow through the region 200 which increases the local velocity of the feed water in region 200. In addition to any mixing that might be caused by the curving flow path, the increase in local velocity also helps reduce concentration polarization in the region 200. Optionally, the location and dimension of the obstructions 190 may be chosen to increase the local velocity of feed flow without also attempting to create micro-mixing effects.

This written description uses examples to disclose embodiments of the invention and also to enable any person skilled in the art to practice embodiments of the invention, including making and using any devices or systems and performing any incorporated methods. The patentable scope of embodiments of the invention is defined by the claims, and may include other examples that occur to those skilled in the art.

1. A feed channel spacer for a spiral wound membrane element having a central area with a first thickness and opposed edges having a second thickness that is less than the first thickness.

2. The feed channel spacer of claim 1 wherein the edges are located on the feed channel spacer such that, in a completed spiral wound membrane element, the edges are placed between lines of adhesive in membrane leaves of the element.

3. The feed channel spacer of claim 1 wherein the second thickness is between 2 and 12 mils less than the first thickness.

4. The feed channel spacer of claim 1 wherein the edges are 50 mm or less in width.

5. The feed channel spacer of claim 1 wherein the edges and the central portion are parts of a common piece of a net or mesh material.

6. The feed channel spacer of claim 1 wherein the edges and the central portion are distinct pieces of material.

7. The feed channel spacer of claim 1 further comprising a region comprising an array of obstructions.

8. A method of making a feed channel spacer comprising a step of compressing two opposed edges of a sheet of a feed channel spacer material to reduce the thickness of the edges.

9. The method of claim 8 further comprising heating the feed channel spacer material while compressing it.

10. The method of claim 9 wherein the feed channel spacer material is made of a thermoplastic material and the step of heating comprises heating the thermoplastic material to at least its heat deflection temperature.

11. The method of claim 8 comprising compressing the edges in a press or between two rollers.

12. A feed channel spacer comprising an array of obstructions in at least a region of the feed channel spacer.

13. The feed channel spacer of claim 12 wherein the obstructions are supported on a net or mesh material or on a central sheet.

14. The feed channel spacer of claim 13 wherein the obstructions are formed in a sheet of thermoplastic material.

15. The feed channel spacer of claim 13 wherein the obstructions are formed by depositing an adhesive or plastic onto a central sheet or onto a mesh or net.

16. The feed channel spacer of claim 12 wherein the region is located in a tip portion of the feed channel spacer.

17. The feed channel spacer of claim 12 wherein the obstructions are positioned in an array wherein subsequent rows of obstructions are offset from each other.

18. The feed channel spacer of claim 17 wherein the obstructions create a curving feed flow path having sections with a radius of curvature of 10 mm or less.
